(19) United States
(12) Patent Application Publication
(10) Pub. No.: US 2008/0167157 A1
(43) Pub. Date: Jul. 10, 2008

(54) Automatic Transmission and Gear Train

(75) Inventors: Jack Creighton, Hickory, PA (US); Scott Dalenberg, Springfield, MO (US); Grady Jackson Smith, Mansfield, TX (US)

Correspondence Address: CROWELL & MORING LLP;INTELLECTUAL PROPERTY GROUP, P.O. BOX 14300, WASHINGTON, DC, 20044-4300, US

(73) Assignee: Axiom Automotive Technologies, Inc., Pittsburgh, PA (US)

(21) Appl. No.: 11/950,846

(22) Filed: Dec. 5, 2007

Related U.S. Application Data
(60) Provisional application No. 60/873,023, filed on Dec. 6, 2006.

(51) Int. Cl. F16H 3/44

(52) U.S. Cl. 475/269; 475/342; 475/331

(57) ABSTRACT

An automatic transmission assembly is constructed or modified to minimize effects of wear thereon and maximize its operational life. The assembly includes a transmission case and has a modified ring-shaped center support that is to be secured against rotation within the transmission case. A center support plate, which is attachable to and detachable from the ring-shaped center support, includes protrusions thereon that engage between cooperating protrusions defined on the transmission case to secure the ring-shaped center support against rotation within the transmission case. The invention is particularly useful when the modified ring-shaped center support is a worn, original equipment support that has deteriorated in function. A process of modifying an automatic transmission assembly is also described.

This application claims the priority of U.S. Provisional Application Ser. No. 60/873,023, filed Dec. 6, 2006, the entire disclosure of which is incorporated herein by reference.

### BACKGROUND OF THE INVENTION

1. Field of the Invention

The present invention relates to automatic transmissions and gear trains. In particular, this invention relates to an improved automatic transmission with a fully engaging center support.

2. Description of Related Art

A motorized vehicle typically includes a power train having an engine, a multi-speed transmission, and a differential or final drive. The multi-speed transmission increases the overall operating range of the vehicle by permitting the engine to operate through its torque range a number of times. The number of forward speed ratios that are available in the transmission determines the number of times the engine torque range is repeated. Early automatic transmissions had two speed ranges. This severely limited the overall speed range of the vehicles and, therefore, required relatively large engines that could produce wide speed and torque ranges. This, in turn, resulted in increased engine wear and tear and reduced engine efficiency. Therefore, manually-shifted transmissions were the most popular form used in motor vehicles.

With the advent of three- and four-speed automatic transmissions, the automatic shifting (planetary gear) transmission increased in popularity. This form of transmission improved the operating performance and fuel economy of the vehicle. The increased number of speed ratios reduced the step size between ratios and therefore improved the shift quality of the transmission by making the ratio interchanges substantially imperceptible to the operator under normal vehicle acceleration.

One aspect of the instant invention is a redesign of an automatic transmission that has a high failure rate in its present application. The United States Postal Service (USPS) fleet has 145,000 vehicles on the road, each with a service life of 25 or more years. These vehicles rely on the conventional 180C transmission and/or the conventional 700R4 transmission. The 700R4 transmission was introduced into the fleet as an alternative to remanufacturing the 180C. This transmission has a much higher torque capacity than the standard 180C, but also has inherent failure characteristics which are revealed when it is required to perform within the requirements of a postal delivery vehicle duty cycle. High vehicle down time due to inherent 700R4 transmission design problems have plagued this fleet for the past 15 years. During the last 15 years, the USPS has utilized local and regional re-builders to supply replacement products to keep their fleet on the road. The 700R4 transmission is a GM unit that has been in the marketplace for many years. This unit was not designed for the Postal LLV application and had to have a modified conversion kit to adapt to the USPS vehicle. This kit included a drive shaft, an adapter plate, a shift linkage, and a torque converter. Because there was no controlled testing and evaluation at the inception of this 700R4 transmission, there were high failure rates in the field.

The 700R4 transmission historically fails in four ways.

1. Three/four clutch failure.
2. Two/four band failure
3. Rear planetary failure
4. Case lug failure.

The nature of the use of the 700R4 transmission by the USPS results in constant shifting from first gear to second gear and back down to first gear. This shifting sequence typically occurs hundreds of times per vehicle in one day of service. The 700R4 transmission was designed to shift first to second to third and then to fourth. The converter clutch would then be applied, and the driver and vehicle would proceed to a destination. Thus, most of the transmission's useful service would be spent in third and fourth gears. The 700R4 transmission as used by the Postal Service does not see such a sheltered life. After repeated first to second and then second to first shifts, the pinion gears within the 700R4 gear train begin to spall.

Spalling of the gears results in very small, yet very hard pieces of steel flaking off the pressure angle surface of each pinion gear. These pieces of steel are washed away from the pinion gears by the oil that lubricates and cools these same gears; thus, the pieces of hard steel are suspended in the oil. As the oil circulates, in this case by being pumped to all critical areas of the transmission, these pieces of metal act as an abrasive on all parts they contact. As one might suspect, the abrasive action of the steel particles wears the surfaces of all mating and moving parts. As gear deterioration progresses, the hard steel particles become more concentrated in the oil and become lodged in the valves of the valve body. This results in the transmission not shifting properly and burning the three/four clutch and the two/four band. The case lugs are worn as a result of the forces placed on it by the center support when the sprag (which is nested in the center of the center support) is held in first gear and/or slammed during a two-to-one down shift.

One manner of providing an automatic transmission with improved deterioration resistance and an increased effective life forms the subject matter of commonly owned U.S. Pat. No. 7,195,578 to Dalenberg et al., the entire disclosure of which is incorporated herein by reference as non-essential material. As discussed in that patent, a reduction in the load each gear must transfer is provided by adding a fourth pinion gear to the carrier, in combination with certain other operations, to reduce the amount of torque transferred by each gear. Adopting the modifications outlined in the Dalenberg et al. ('578) patent permits the system to be kept free of harmful contamination and functioning properly for a longer period.

### SUMMARY OF THE INVENTION

According to the present invention, an automatic transmission assembly is constructed or modified to minimize effects of wear thereon and maximize its operational life. The assembly, which includes a transmission case, has a modified ring-shaped center support that is to be secured against rotation within the transmission case. A center support plate, which is attachable to and detachable from the ring-shaped center support, includes protrusions thereon that engage between cooperating protrusions defined on the transmission case to secure the ring-shaped center support against rotation within the transmission case. The ring-shaped center support is modified by incorporating bores adapted to receive fasteners to attach the center support plate to the center support. In a preferred configuration, the bores are threaded bores, the fasteners are screws receivable in the threaded bores, and the protrusions are lugs defined on an outer circumference of the center support plate and lugs defined on an inner circumference of the transmission case. The invention is particularly useful when the modified ring-shaped center support is a worn, original equipment support that has deteriorated in function.

The invention additionally concerns a process of modifying an automatic transmission assembly so as to minimize effects of wear thereon and maximize operational life thereof. In this process, bores, adapted to receive fasteners by which a center support plate is attachable to a center support of the automatic transmission assembly, are incorporated into the center support, and the center support plate is attached to the center support with the fasteners. The center support with the center support plate attached is then placed into a transmission case so that lugs or other protrusions on an outer circumference of the center support plate engage between cooperating lugs or other protrusions defined on the transmission case to secure the ring-shaped center support against rotation within the transmission case.

### BRIEF DESCRIPTION OF THE DRAWINGS

FIG. 1 shows a plan view of a blank for a plate and, below that, a sectional view of a finished plate mountable to a center support according to the invention.

FIG. 2 is a perspective view of an original equipment four pinion rear planetary assembly.

FIG. 3 is a perspective view similar to that of FIG. 2 but of a five pinion rear planetary assembly providing improved wear characteristics.

FIG. 4 is a view of the interior of a transmission case showing the general area of worn transmission case center support lugs.

FIG. 5 is an enlarged view of a portion of the transmission case shown in FIG. 4 providing an enlarged view of center support lug wear.

FIG. 6 is a view of a transmission case with a center support installed.

FIG. 7 is a view of the transmission case of FIG. 6, with the installed center support rotated clockwise and showing wear.

FIG. 8 is a view similar to that of FIG. 7 but with the center support rotated counter-clockwise and showing wear.

FIG. 9 is a view of an altered center support with center support attachment cap screws and a center support plate that is mountable to the altered center support.

FIG. 10 shows the center support plate with a center support mounted thereon after assembly and following insertion into the transmission case interior.

FIG. 11 shows an improved three/four clutch set that can assist in further extending transmission life.

FIG. 12 shows an improved two/four clutch band that can also assist in further extending transmission life.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implicated in other compositions and methods, and that any such variation would be within such modifications that do not part from the scope of the present invention. Before explaining the disclosed embodiments of the present invention in detail, it is to be understood that the invention is not limited in its application to the details of any particular embodiment shown, since of course the invention is capable of other embodiments. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

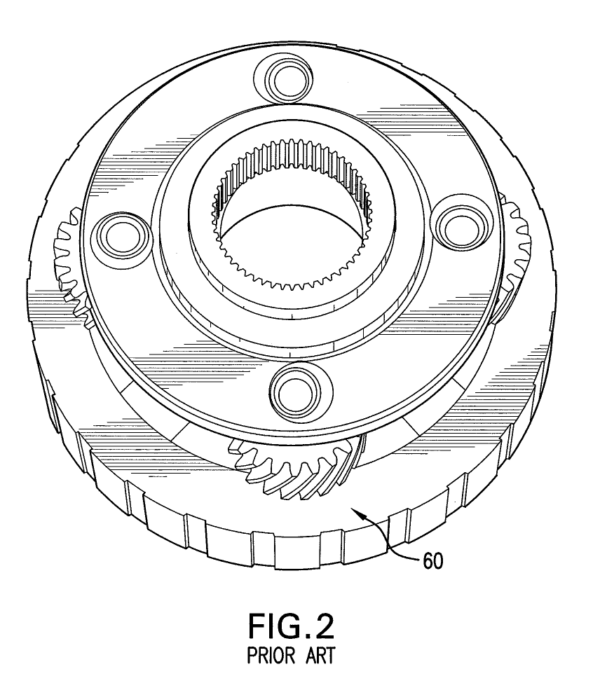

An improvement to the planetary gear assembly is now described. It will be understood by those of ordinary skill in the art that the original equipment planetary gear assembly shown in FIG. 2 is currently in use as a part of the conventional 700R4 transmission used for years in USPS vehicles.

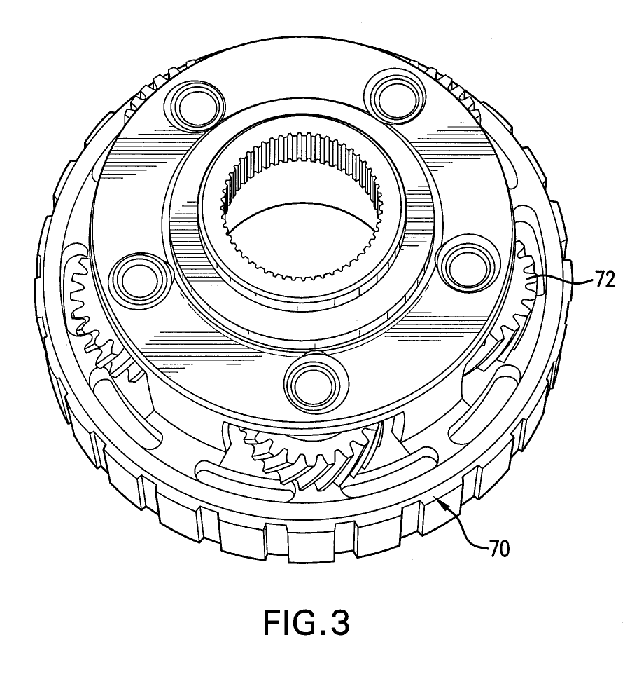

The re-engineered planetary gear assembly shown in FIG. 3 is intended for use in connection with the 800PS transmission forming the subject matter of the provisional application noted above. This re-engineered gear assembly, however, could alternatively be used to replace the conventional four pinion assembly shown in FIG. 2 to provide improved wear resistance characteristics in a conventional 700R4 transmission system.

More particularly, current state of the art configurations use four (4) pinion planetary arrangements such as the four pinion planetary arrangement 60 illustrated in FIG. 2. The planetary arrangement 70 illustrated in FIG. 3 includes five (5) pinion gears 72. Each pinion gear 72 of FIG. 3 carries its share of the torque. If only four pinion gears are involved with the torque transfer from the engine to the ground, as in the prior art assembly shown in FIG. 2, each pinion gear within the planetary arrangement will share twenty five percent (25%) of the total load. By adding an additional, fifth planetary pinion gear 72 in the configuration shown in FIG. 3, the load is reduced on each planetary gear to twenty percent (20%). This modification extends the life of the planetary gear set. By extending the planetary gear set life by twenty percent (20%), for example, creation of small metal particles is postponed by at least that much time, thus extending the life of the transmission by at least twenty percent over its current projected life. Rear planetary failure is thus preferably repaired by re-engineering the planet assembly from a four pinion assembly, as shown in FIG. 2, to a five pinion assembly, as shown in FIG. 3.

According to this invention, case lug failure is repaired by installing a custom center support plate, which, when installed on the altered original center support, guarantees maximum center support engagement to the case. This engagement insures that this point of failure is eliminated for the remaining life of the transmission.

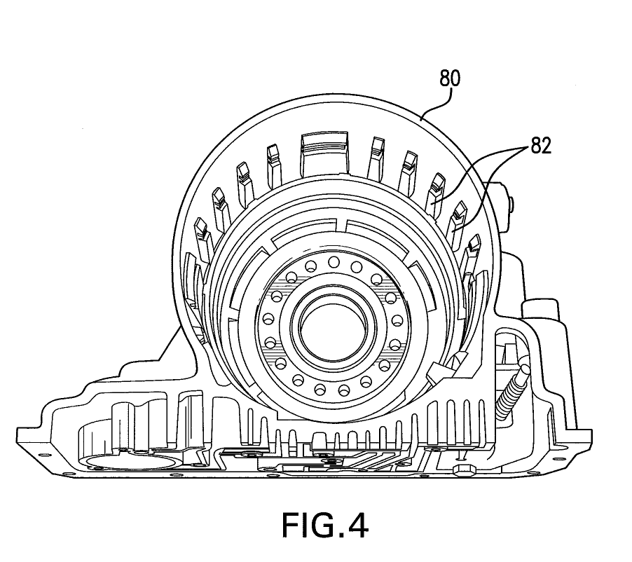

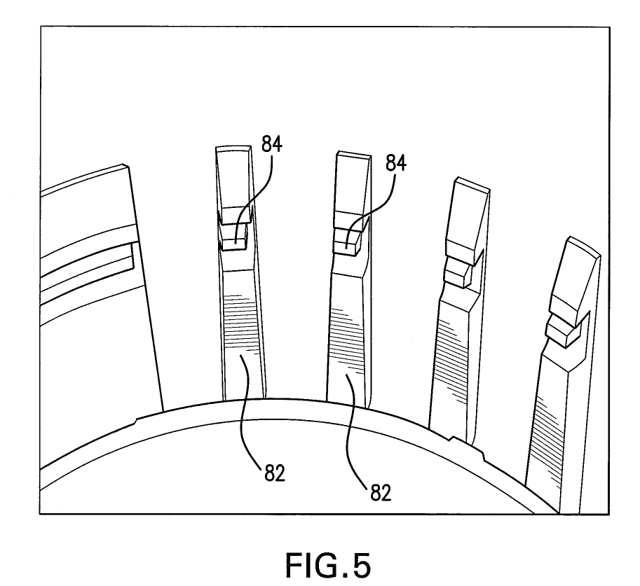

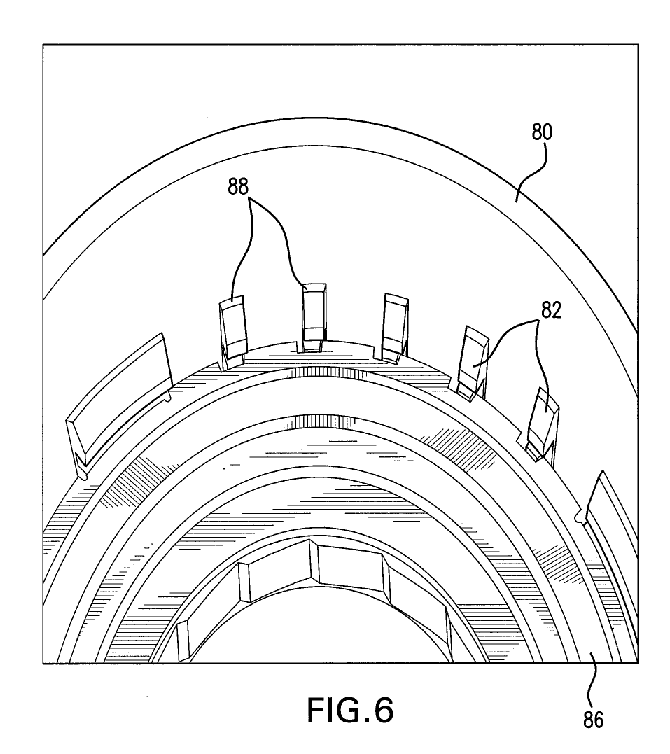

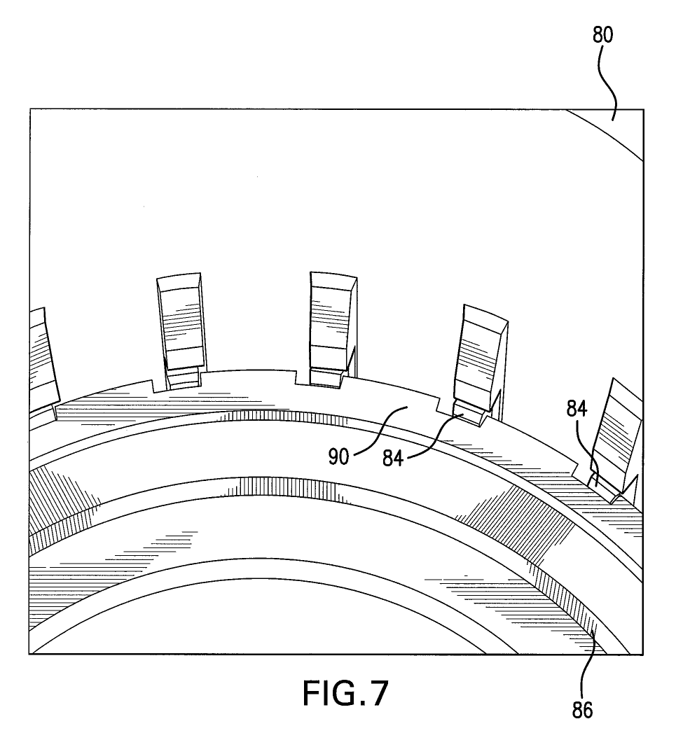

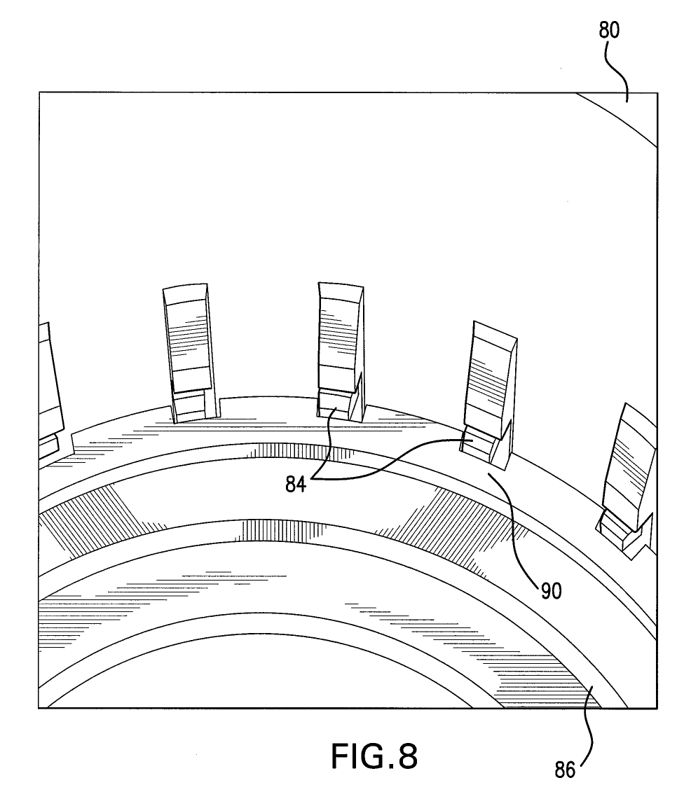

FIG. 4 illustrates a worn transmission case showing the center support lug area, while FIG. 5 shows a close up of the worn center support lug area. This center support lug area has a plurality of lugs 82 extending in an axial direction along the circumferentially inner surface of the case 80. Each of the lugs 82 has an engagement location 84, best shown in FIG. 5, that cooperates with recesses 88 defined in the disc or plate defining the center support 86 to retain the center support 86 (FIG. 6) in place, without rotation, while the overall transmission system operates in its lowermost gear. FIG. 6 illustrates an unaltered center support in the transmission case, while the enlarged views provided by FIGS. 7 and 8 show heavy wear existing between the lugs of the transmission center support 86 and the center support lugs 82 of the case 80. It will be recognized that the transmission case centers the support lugs, that the center support is rotated clockwise in FIG. 7, and that the center support is rotated counter clockwise in FIG. 8.

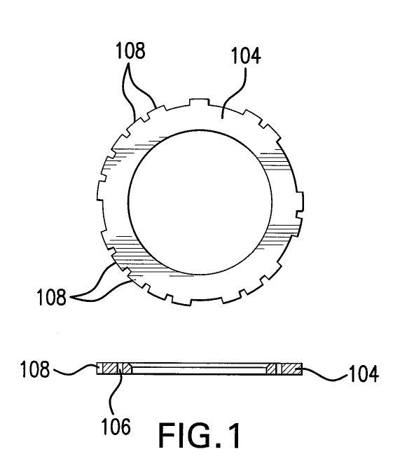

Over time, the lug engagement locations 84, the side walls delimiting the center support recesses 88, or both become worn and deteriorate, leading to circumferential play 90 between the center support 86 and the lug engagement locations 84 and, therefore, the case 80 as a whole. If the metal in the case center support area is worn away, a malfunction will occur. This malfunction manifests itself in a “no-move” situation. FIGS. 5-8 show a transmission case in which the lugs are at least fifty percent (50%) spent, and the case thus will not last the desired three to four additional years in service. By installing the modified center support and the center support plate of this invention, the life of the transmission case can be restored to at least its original duration and perhaps more. At the same time, the circumferential play 90, which is apparent by a comparison of FIGS. 7 and 8, is effectively eliminated by the addition of the custom support plate 104 illustrated in FIGS. 1, 9, and 10.

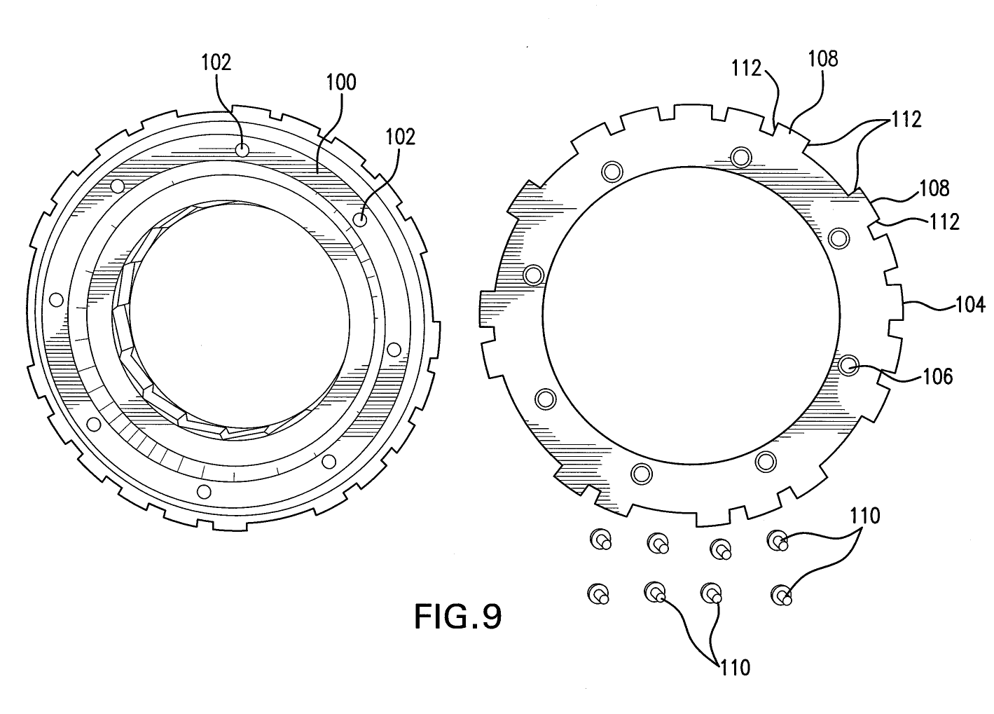

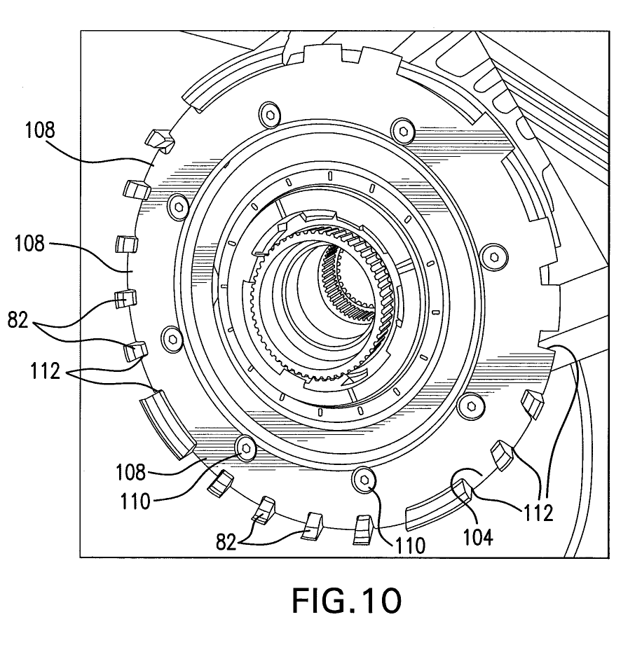

FIG. 9 illustrates an altered center support 100, which is modified according to this invention in order to accept the custom Axiom center support plate 104. The center support 100 of FIG. 9 has a plurality of threaded bores or recesses 102 machined or otherwise formed therein, but otherwise may be essentially identical to the worn center support 86 illustrated, inter alia, in FIG. 6. Of course, the bores or recesses 102 could also be provided in a new, unworn center support, which then would serve as the “altered” center support 100. The plate 104 shown in FIG. 9 and elsewhere can be a steel stamping or casting, but may also be of any other relatively rigid and wear resistant material appropriate for use in an automotive transmission environment. The plate 104 includes holes 106 defined therein and lugs 108 disposed around the outer circumference thereof. Attachment cap screws 110 are passed through the holes 106 and screwed into the threaded bores or recesses 102 of the center support 100 to rigidly and securely fasten the center support plate 104 of this invention to the center support 100 in the manner shown in FIG. 10. The use of screws also facilitates subsequent detachment of the plate 104 from the center support 100, if necessary. The lateral edges 112 of the lugs 108 disposed around the outer circumference of the plate 104 can then be used in place of the ineffective, worn side walls delimiting the recesses 88 to engage with the lugs 82 extending along the circumferentially inner surface of the case 80. By adding the center support plate 104 to the center support 100, therefore, it is possible to essentially reverse or eliminate the circumferential play 90 existing between an unaltered center support 86 and the lug engagement locations 84 and, therefore, the case 80 as a whole.

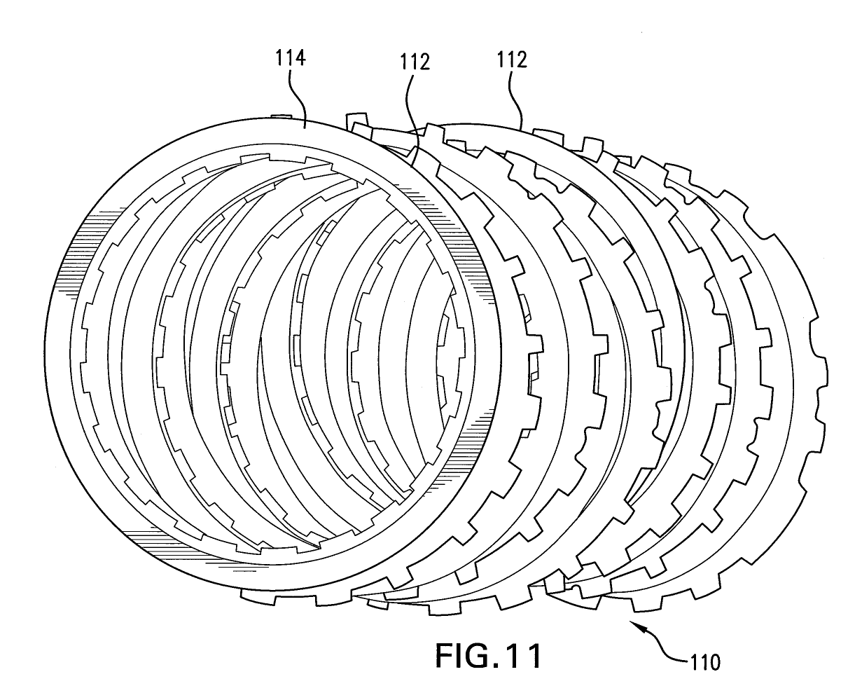

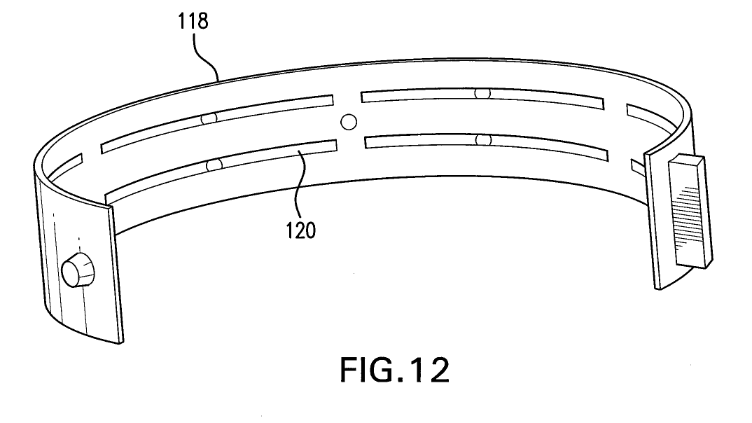

The improved three/four clutch set shown in FIG. 11 can assist in further extending transmission life. The improvement is produced by replacing friction rings having conventional celluloid linings with friction rings 112 having friction linings 114 composed of approximately 12% KEVLAR and 88% celluloid. Finally, the improved two/four clutch band 118 shown in FIG. 12 can also assist in further extending transmission life. To provide this further improvement, the band 118 illustrated in FIG. 12 is supplied with appropriate friction linings, again, composed of approximately 12% KEVLAR and 88% celluloid.

While the invention has been described with an emphasis on particular embodiments thereof, those skilled in the art may make various modifications to the described embodiments of the invention without departing from the scope of the invention. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

1. An automatic transmission assembly adapted to minimize effects of wear thereon and maximize operational life thereof comprising:
a transmission case,
a ring-shaped center support that is to be secured against rotation within said transmission case, and
a center support plate attachable to and detachable from the ring-shaped center support and including protrusions thereon that engage between cooperating protrusions defined on the transmission case to secure said ring-shaped center support against rotation within the transmission case.

2. The assembly according to claim 1, wherein the protrusions are lugs defined on an outer circumference of the center support plate and lugs defined on an inner circumference of the transmission case.

3. The assembly according to claim 1, wherein the center support is a worn, original equipment support that is modified to receive the center support plate.

4. The assembly according to claim 3, wherein attachment of the center support plate to said ring-shaped center support compensates for wear of said original equipment support.

5. The assembly according to claim 1, wherein the center support plate is attachable to the ring-shaped center support by a plurality of screws passing through the center support plate.

6. An automatic transmission assembly that is modified to minimize effects of wear thereon and maximize operational life thereof comprising:
a transmission case,
a modified ring-shaped center support that is to be secured against rotation within said transmission case, and
a center support plate attachable to and detachable from the ring-shaped center support and including protrusions thereon that engage between cooperating protrusions defined on the transmission case to secure said ring-shaped center support against rotation within the transmission case,
wherein the ring-shaped center support is modified by incorporating bores adapted to receive fasteners to attach the center support plate to the center support.

7. The assembly according to claim 6, wherein the bores are threaded bores, and wherein the fasteners are screws receivable in the threaded bores.

8. The assembly according to claim 6, wherein the protrusions are lugs defined on an outer circumference of the center support plate and lugs defined on an inner circumference of the transmission case.

9. The assembly according to claim 1, wherein the modified ring-shaped center support is a worn, original equipment support that is provided with threaded bores.

10. A process of modifying an automatic transmission assembly so as to minimize effects of wear thereon and maximize operational life thereof comprising:
incorporating bores, adapted to receive fasteners by which a center support plate is attachable to a center support of the automatic transmission assembly, into said center support,
attaching the center support plate to the center support by way of said fasteners,
placing the center support with the center support plate attached thereto into a transmission case so that protrusions on an outer circumference of the center support plate engage between cooperating protrusions defined on the transmission case to secure said ring-shaped center support against rotation within the transmission case.
